(19) United States
(12) Patent Application Publication
(10) Pub. No.: US 2013/0215027 A1
(43) Pub. Date: Aug. 22, 2013

(54) Evaluating an Input Relative to a Display

(71) Applicants: Curt N. Van Lydegraf, Eagle, ID (US); Robert Campbell, Cupertino, CA (US); Bradley Neal Suggs, Sunnyvale, CA (US)

(72) Inventors: Curt N. Van Lydegraf, Eagle, ID (US); Robert Campbell, Cupertino, CA (US); Bradley Neal Suggs, Sunnyvale, CA (US)

(21) Appl. No.: 13/819,088

(22) PCT Filed: Oct. 22, 2010
(86) PCT No.: PCT/US2010/053820

§ 371 Date: Feb. 26, 2013

(51) Int. Cl. G06F 3/01

(52) U.S. Cl. CPC G06F 3/017
USPC 345/158

(57) ABSTRACT

Disclosed embodiments relate to evaluating an input relative to a display. A processor may receive information from an optical sensor 106 and a depth sensor 108. The depth sensor 108 may sense the distance of an input from the display. The processor may evaluate an input to the display based on information from the optical sensor 106 and the depth sensor 108.

### BACKGROUND

Electronic devices may receive user input from a peripheral device, such as from a keyboard or a mouse. In some cases, electronic devices may be designed to receive user input directly from a user interacting with a display associated with the electronic device, such as by a user touching the display or gesturing in front of it. For example, a user may select an icon, zoom in on an image, or type a message by touching a touch screen display with a finger or stylus.

### BRIEF DESCRIPTION OF THE DRAWINGS

In the accompanying drawings, like numerals refer to like components or blocks. The drawings describe example embodiments. The following detailed description references the drawings, wherein:

FIG. 1 is a block diagram illustrating one example of a display system.

FIG. 2 is a block diagram illustrating one example of a display system.

FIG. 3 is a flow chart illustrating one example of a method for evaluating an input relative to a display.

FIG. 4 is a block diagram illustrating one example of properties of an put evaluated based on information from an optical sensor and a depth sensor.

FIG. 5 is a block diagram illustrating one example of a display system.

FIG. 6 is a block diagram illustrating one example of a display system.

FIG. 7 is a flow chart illustrating one example of a method for evaluating an input relative to a display.

FIG. 8 is block diagram illustrating one example of characteristics of an input determined based on information from an optical sensor and a depth sensor.

### DETAILED DESCRIPTION

Electronic devices may receive user input based on user interactions with a display. A sensor associated with a display may be used to sense information about a user's interactions with the display. For example, a sensor may sense information related to the position of a touch input. Characteristics of an input may be used to determine the meaning of the input, such as whether a particular item shown on a display was selected. User interactions with a display may have multiple dimensions, but some input sensing technology may have limits in their ability to measure some aspects of the user input. For example, a particular type of sensor may be better tailored to measuring an x-y position of an input across the display than to measuring the distance of the input from the display.

In one embodiment, a processor evaluates an input relative to a display based on multiple types of input sensing technology. For example, a display may have a depth sensor and an optical sensor associated with it for measuring user interactions with the display. The depth sensor and optical sensor may use different sensing technologies, such as where the depth sensor is an infrared depth map and the optical sensor is a camera or where the depth sensor and optical sensor are different types of cameras. Information from the optical sensor and depth sensor may be used to determine the characteristics of an input relative to the display. For example, information about the position, pose, orientation, motion, or gesture characteristics of the input may be analyzed based on information received from the optical sensor and the depth sensor.

The use of an optical sensor and depth sensor using different types of sensing technologies to measure an input relative to a display may allow more features of an input to be measured than possible with a single type of sensor. In addition, the use of an optical sensor and a depth sensor may allow one type of sensor to compensate for the weaknesses of the other type of sensor. In addition, a depth sensor and optical sensor may be combined to provide a cheaper input sensing system, such as by having fewer sensors using high cost technology for one function and combining them with a lower cost sensing technology for another function.

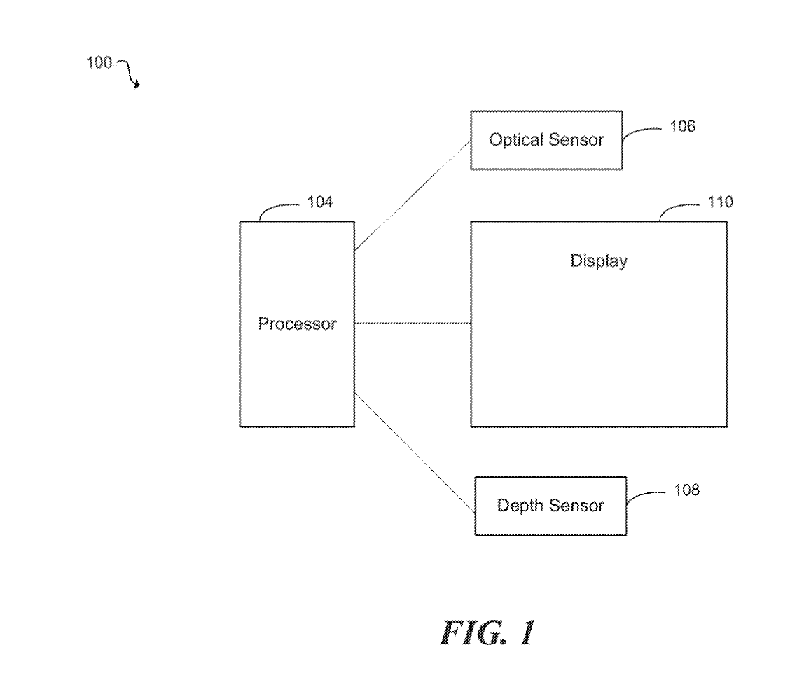

FIG. 1 is a block diagram illustrating one embodiment of a display system 100. The display system 100 may include, for example, a processor 104, an optical sensor 106, a depth sensor 108, and a display 110.

The display 110 may be any suitable display. For example, the display 110 may be a Liquid Crystal Display (LCD). The display 110 may be a screen, wall, or other object with an image projected on it. The display 110 may be a two-dimensional or three-dimensional display. In one embodiment, a user may interact with the display 110, such as by touching it or performing a hand motion in front of it.

The optical sensor 106 may be any suitable optical sensor for receiving input related to the display 110. For example, the optical sensor 106 may include a light transmitter and a light receiver positioned on the display 110 such that the optical sensor 106 transmits light across the display 110 and measures whether the light is received or interrupted, such as interrupted by a touch to the display 110. The optical sensor 106 may be a frustrated total internal reflection sensor that sends infrared light across the display 110. In one implementation, the optical sensor 106 may be a camera, such as a camera for sensing an image of an input. In one implementation, the display system 100 includes multiple optical sensors. The multiple optical sensors may use the same or different types of technology. For example, the optical sensors may be multiple cameras or a camera and a light sensor.

The depth sensor 108 may be any suitable sensor for measuring the distance of an input relative to the display 110. For example, the depth sensor 108 may be an infrared depth map, acoustic sensor, time of flight sensor, or camera. The depth sensor 108 and the optical sensor 106 may both be cameras. For example, the optical sensor 106 may be one type of camera, and the depth sensor 108 may be another type of camera. In one implementation, the depth sensor 108 measures the distance of an input relative to the display 110, such as how far an object is in front of the display 110. The display system 100 may include multiple depth sensors, such as multiple depth sensors using the same sensing technology or multiple depth sensors using different types of sensing technology. For example, one type of depth sensor may be used in one location relative to the display 110 with a different type of depth sensor in another location relative to the display 110.

In one implementation, the display system 100 includes other types of sensors in addition to a depth sensor and optical sensor. For example, the display system 100 may include a physical contact sensor, such as a capacitive or resistive sensor overlaying the display 110. Additional types of sensors may provide information to use in combination with information from the depth sensor 108 and optical sensor 106 to determine the characteristics of the input or may provide information to be used to determine additional characteristics of the input.

The optical sensor 106 and the depth sensor 108 may measure the characteristics of any suitable input. The input may be created, for example, by a hand, stylus, or other object, such as a video game controller. In one implementation, the optical sensor 106 may determine the type of object creating the input, such as whether it is performed by a hand or other object. For example, the input may be a finger touching the display 110 or a hand motioning in front of the display 110. In one embodiment, the processor 104 analyzes multiple inputs, such as multiple fingers from a hand may touch the display 110. For example, two fingers touching the display 110 may be interpreted to have a different meaning than a single finger touching the display 110.

The processor 104 may be any suitable processor, such as a central processing unit (CPU), a semiconductor-based microprocessor, or any other device suitable for retrieval and execution of instructions. In one embodiment, the display system 100 includes logic instead of or in addition to the processor 104. As an alternative or in addition to fetching, decoding, and executing instructions, the processor 104 may include one or more integrated circuits (ICs) or other electronic circuits that comprise a plurality of electronic components for performing the functionality described below. In one implementation, the display system 100 includes multiple processors. For example, one processor may perform some functionality and another processor may perform other functionality.

The processor 104 may process information received from the optical sensor 106 and the depth sensor 108. For example, the processor 104 may evaluate an input relative to the display 110, such as to determine the position or movement of the input, based on information from the optical sensor 106 and the depth sensor 108. In one implementation, the processor 104 receives information from the optical sensor 106 and the depth sensor 108 from the same sensor. For example, the optical sensor 106 may receive information from the depth sensor 108, and the optical sensor 106 may communicate information sensed by the optical sensor 106 and the depth sensor 108 to the processor 104. In some cases, the optical sensor 106 or the depth sensor 108 may perform some processing on collected information prior to communicating it to the processor 104.

In one implementation, the processor 104 executes instructions stored in a machine-readable storage medium. The machine-readable storage medium may be any electronic, magnetic, optical, or other physical storage device that stores executable instructions or other data (e.g., a hard disk drive, random access memory, flash memory, etc.). The machine-readable storage medium may be, for example, a computer readable non-transitory medium. The machine-readable storage medium may include instructions executable by the processor 104, for example, instructions for determining the characteristics of an input relative to the display 110 based on the received information from the optical sensor 106 and the depth sensor 108.

The display system 100 may be placed in any suitable configuration. For example, the optical sensor 106 and the depth sensor 108 may be attached to the display 110 or may be located separately from the display 110. The optical sensor 106 and the depth sensor 108 may be located in any suitable location with any suitable positioning relative to one another, such as overlaid on the display 110, embodied in another electronic device, or in front of the display 110. The optical sensor 106 and the depth sensor 108 may be located in separate locations, such as the optical sensor 106 overlaid on the display 110 and the depth sensor 108 placed on a separate electronic device. In one embodiment, the processor 104 is not directly connected to the optical sensor 106 or the depth sensor 108, and the processor 104 receives information from the optical sensor 106 or the depth sensor 108 via a network. In one embodiment, the processor 104 is contained in a separate enclosure than the display 110. For example, the processor 104 may be included in an electronic device for projecting an image on the display 110.

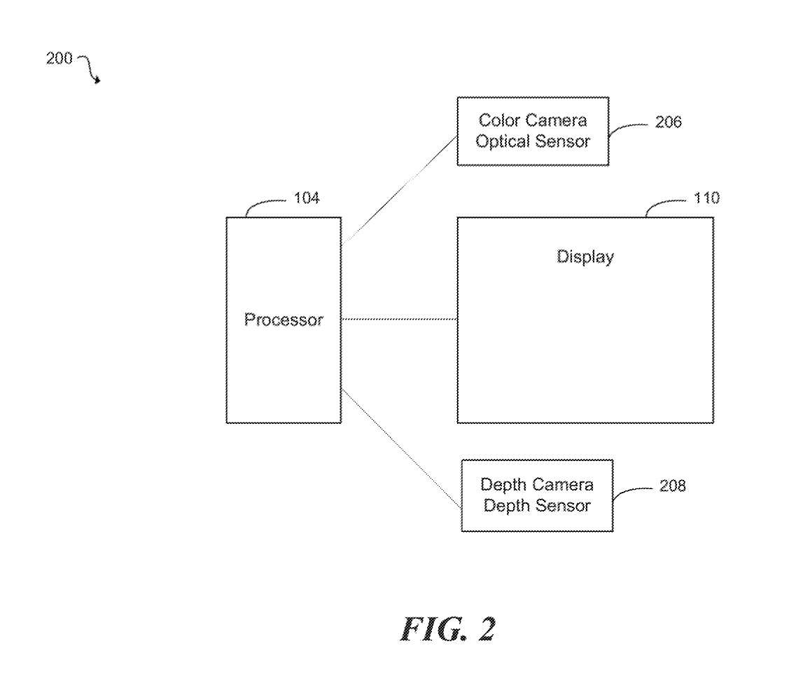

FIG. 2 is a block diagram illustrating one example of a display system 200. The display system 200 may include the processor 104 and the display 110. The display system 200 shows one example of using one type of sensor as an optical sensor and another type of sensor as a depth sensor. The display system 200 includes one type of camera for the optical sensor 206 and another type of camera for the depth sensor 208. For example, the optical sensor 206 may be a camera for sensing color, such as a webcam, and the depth sensor 208 may be a camera for sensing depth, such as a time of flight camera.

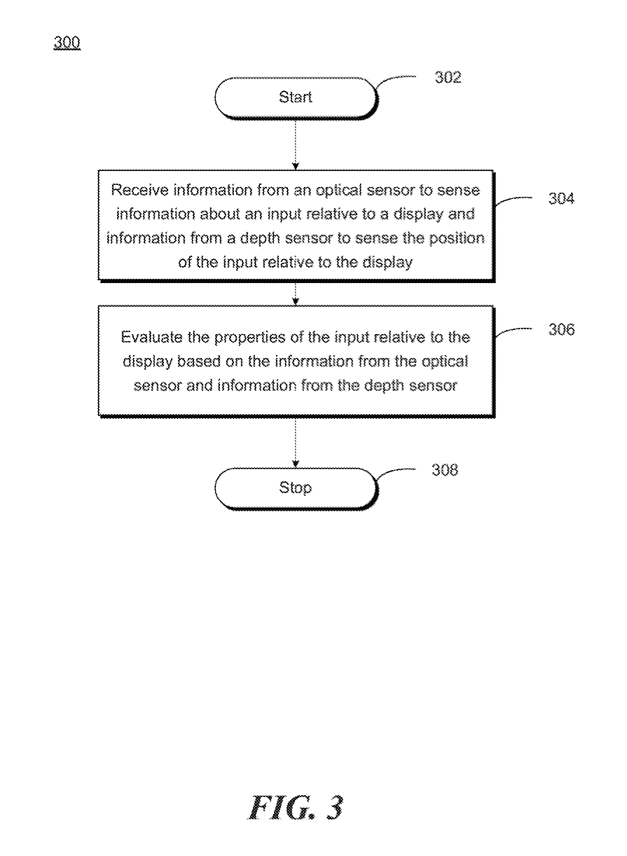

FIG. 3 is a flow chart illustrating one example of a method 300 for evaluating an input relative to a display. For example, a processor may receive information about an input relative to a display from the optical sensor and the depth sensor. The processor may be any suitable processor, such as a central processing unit (CPU), a semiconductor-based microprocessor, or any other device suitable for retrieval and execution of instructions. The processor may determine the characteristics of an input relative to the display using the information from the optical sensor and the depth sensor. For example, the processor may determine which pose an input is in and determine the meaning of the particular pose, such as a pointing pose indicating that a particular object shown on the display is selected. In one implementation, the method 300 may be executed on the system 100 shown in FIG. 1.

Beginning at block 302 and moving to block 304, the processor, such as by executing instructions stored in a machine-readable storage medium, receives information from the optical sensor to sense information about an input relative to the display and information from the depth sensor to sense the position of the input relative to the display. The display may be, for example, an electronic display, such as a Liquid Crystal Display (LCD), or a wall or other object that may have an image projected upon it.

The optical sensor may be any suitable optical sensor, such as a light transmitter and receiver or a camera. The optical sensor may collect any suitable information. For example, the optical sensor may capture an image of the input that may be used to determine the object performing the input or the pose of the input. The cal sensor may be a light sensor capturing information about a position of the input.

The information from the optical sensor may be received in any suitable manner. For example, the processor may retrieve the information, such as from a storage medium. The processor may receive the information from the optical sensor, such as directly or via a network. The processor may request information from the optical sensor or may receive information from the sensor without requesting it. The processor may receive information from the optical sensor as it is collected or at a particular interval.

The depth sensor may be any suitable depth sensor, such as an infrared depth map or a camera. The depth sensor may measure the position of an input relative to the display. The depth sensor may collect any suitable information related to the distance of the input from the display. For example, the depth sensor may collect information about how far an input is in front of the display. In one implementation, the depth sensor collects information in addition to distance information, such as information about whether an input is to the right or left of the display. The depth sensor may collect information about the distance of the input from the display at different points in time to determine if an input is moving towards or away from the display.

The information the depth sensor may be received in any suitable manner. For example, the depth sensor may send information to the processor directly or via a network. The depth sensor may store information in a database where the stored information is retrieved by the processor.

Continuing to block 306, the processor, such as by executing instructions stored in a machine-readable medium, evaluates the properties of the input relative to the display based on the information from the optical sensor and information from the depth sensor. The processor may evaluate the properties of the input in any suitable manner. For example, the processor may combine information received from the optical sensor with information received from the depth sensor. In some implementations, the processor may calculate different features of an input based on the information from each sensor. For example, the pose of an input may be determined based on information from the optical sensor, and the position of the input may be determined based on information from the depth sensor. In some implementations, the processor may calculate the same feature based on both types of information. For example, the processor may use information from both the optical sensor and the depth sensor to determine the position of the input.

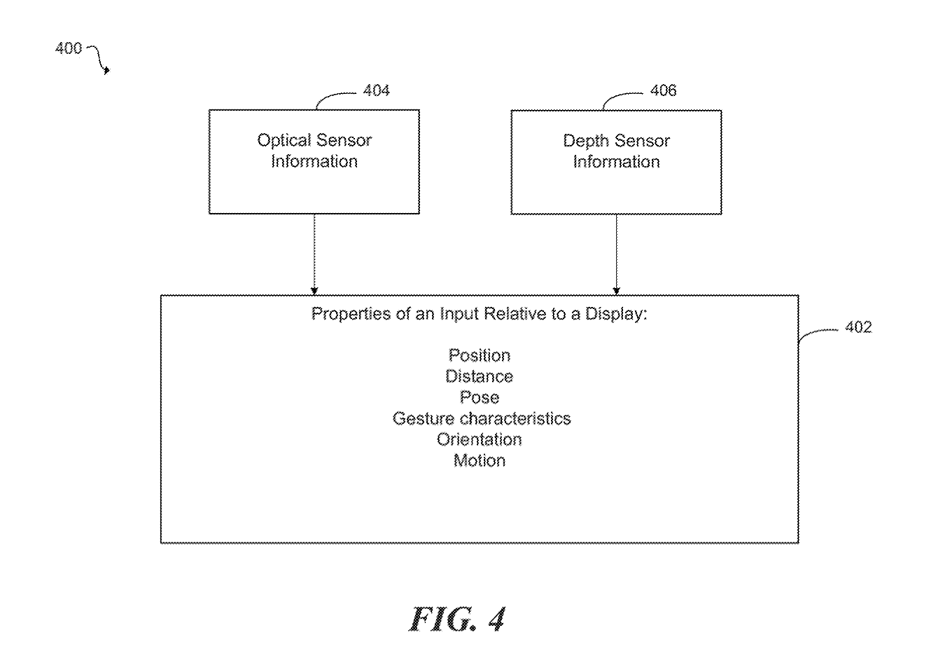

The processor may determine any suitable characteristics of the input relative to the display, such as the properties discussed below in FIG. 4. For example, the processor may evaluate the type of object used for the input, the position of the input, or whether the input is performing a motion or pose. Other properties may also be evaluated using information received from the optical sensor and the depth sensor. The method 300 continues to block 308 and ends.

FIG. 4 is as block diagram illustrating one example 400 of properties of an input evaluated based on information from an optical sensor and a depth sensor. For example, the properties of an input relative to a display may be evaluated based on optical sensor information 404 from an optical sensor and depth sensor information 406 from a depth sensor. Block 402 lists properties example properties that may be evaluated, including the position, pose, gesture characteristics, orientation, motion, or distance of an input. A processor may determine the properties based on information from one of or both of the optical sensor information 404 and the depth sensor information 406.

The position of an input may be evaluated based on the optical sensor information 404 and the depth sensor information 406. For example, the processor may determine that an input is to the center of the display or several feet away from the display. In one implementation, the optical sensor information 404 is used determine an x-y position of the input, and the depth sensor information 406 is used determine the distance of the input from the display.

The processor may evaluate the distance of an input from the display based on the optical sensor information 404 and depth sensor information 406. In one implementation, the processor determines the distance of an input from the display in addition to other properties. For example, one characteristic of an input may be determined based on the optical sensor information 404, and the distance of the input from the display may be determined based the depth sensor information 406. In one implementation, the distance of an input from the display is determined based on both the optical sensor information 404 and the depth sensor information 406.

The pose of an input may be evaluated based on the optical sensor information 404 and the depth sensor information 406. For example, the processor 104 may determine that a hand input is in a pointing pose, a fist pose, or an open hand pose. The processor may determine the pose of an input, for example, using the optical sensor information 404 where the optical sensor is a camera capturing an image of the input.

In one implementation, the processor determines the orientation of an input, such as the direction or angle of an input. For example, the optical sensor may capture an image of an input, and the processor may determine the orientation of the input based on the distance of different portions of the input from the display. In one implementation, the depth sensor information 406 is used with the optical sensor information 404 to determine the orientation of an input, such as based on an image of the input. For example, an input created by a finger pointed towards a display at a 90 degree angle may indicate that a particular object shown on the display is selected, and input created by a finger pointed towards a display at a 45 degree angle may indicate that

[symbol]

In one implementation, the processor determines whether the input is in motion based on the optical sensor information 404 and the depth sensor information 406. For example, the optical sensor may capture one image of the input taken at one point in time and another input of an image taken at another point in time. The depth sensor information 406 may be used to compare the distance of the input to determine whether it is in motion or static relative to the display. For example, the depth sensor may measure the distance of the input from the display at two points in time and compare the distances to determine if the input is moving towards or away from the display.

In one implementation, the processor determines gesture characteristics, such as a combination of the motion and pose, of an input. The optical sensor information 404 and the depth sensor information 406 may be used to determine the motion, pose, or distance of an input. For example, the processor may use the optical sensor information 404 and the depth sensor information 406 to determine that a pointing hand is moved from right to left ten feet in front of the display.

In one implementation, the processor determines three-dimensional characteristics of an input relative to a display based on information from an optical sensor or a depth sensor. The processor may determine three-dimensional characteristics of an input in any suitable manner. For example, the processor may receive a three-dimensional image from an optical sensor or a depth sensor or may create a three-dimensional image by combining information received from the optical sensor and the depth sensor. In one implementation, one of the sensors captures three-dimensional characteristics of an input and the other sensor captures other characteristics of an input. For example, the depth sensor may generate a three-dimensional image map of an input, and the optical sensor may capture color information related to the input.

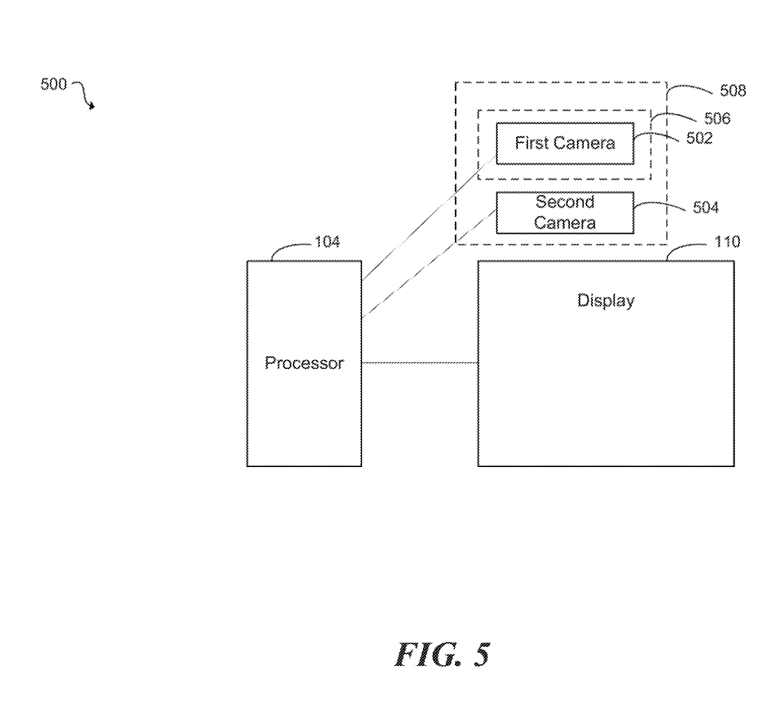

FIG. 5 is a block diagram illustrating one example of a display system 500. The display system 500 includes the processor 104, the display 110, a depth sensor 508, and an optical sensor 506. The depth sensor 508 may include a first camera 502 and a second camera 504. The optical sensor 506 may include one of the cameras, such as the camera 502, included in the depth sensor 508. The first camera 502 and the second camera 504 may each capture an image of the input.

The camera 502 may be used as an optical sensor to sense, for example, color information. The two cameras of the depth sensor 508 may be used to sense three-dimensional properties of an input. For example, the depth sensor 508 may capture two images of an input that may be overlaid to create a three-dimensional image of the input. The three-dimensional image captured by the depth sensor 508 may be used, for example, to send to another electronic device in a video conferencing scenario.

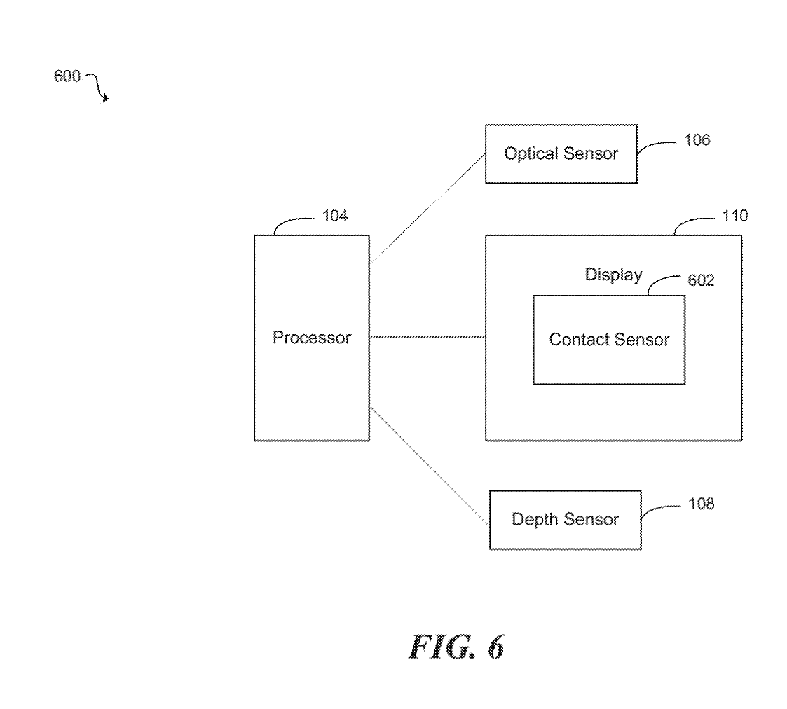

In one implementation, the processor evaluates an input based on information from additional sensors, such as a physical contact sensor. FIG. 6 is a block diagram illustrating one example of a display system 600. The display system 600 includes the processor 104, the display 110, the depth sensor 108, and the optical sensor 106. The display system 600 further includes a contact sensor 602. The contact sensor 602 may be any suitable contact sensor, such as a resistive or capacitive sensor for measuring contact with the display 110. For example, as resistive sensor may be created by placing over a display two metallic electrically conductive layers separated by a small gap. When an object presses the layers and connects them, a change in the electric current may be registered as a touch input. A capacitive sensor may be created with active elements or passive conductors overlaying a display. The human body conducts electricity, and a touch may create a change in the capacitance.

The processor 104 may use information from the contact sensor 602 in addition to information from the optical sensor 106 and the depth sensor 108. For example, the contact sensor 602 may be used to determine the position of a touch input on the display 110, the optical sensor 106 may be used to determine the characteristics of inputs further from the display 110, and the depth sensor 108 may be used to determine whether an input is a touch input or an input further from the display 110.

A processor may determine the meaning of an input based on the determined characteristics of an input. The processor may interpret an input in any suitable manner. The processor may determine the meaning of an input based on the determined characteristics of the input. For example, the position of an input relative to the display may indicate whether a particular object is selected. As another example, a movement relative to the display may indicate that an object shown on the display should be moved. The meaning of an input may vary based on differing characteristics of an input. For example, a hand motion made at one distance from the display may have a different meaning than a hand motion made at a second distance from the display. A hand pointed at one portion of the display may indicate that a particular object is selected, and a hand pointed at another portion of the display may indicate that another object is selected.

In one implementation, an optical sensor may be tailored to sensing an input near the display without a separate contact sensor, such as the contact sensor 602 shown in FIG. 6. For example, the optical sensor, such as the optical sensor 106 shown in FIG. 1, may collect information about the x-y position of an input relative to the display, such as an input near the display, and the depth sensor, such as the depth sensor 108 shown in FIG. 1, may collect information about the distance of the input from the display. The optical sensor may be a two dimensional optical sensor that includes a light source sending light across a display. If the light is interrupted, an input may be detected. In some cases, sensors tailored to two-dimensional measurements may be unable to measure other aspects of an input, such as the distance of the input from the display or the angle of the input. For example, an optical sensor with a transmitter and receiver overlaid on the display may sense the x-y position of an input within a threshold distance of the display, but in some cases this type of optical sensor may not measure the distance of the input from the display, such as whether the input makes contact with the display. The depth sensor may compensate by measuring the distance of the input from the display. The processor may determine the characteristics of the input, such as whether to categorize the input as a touch input, based on information received from the optical sensor and the depth sensor.

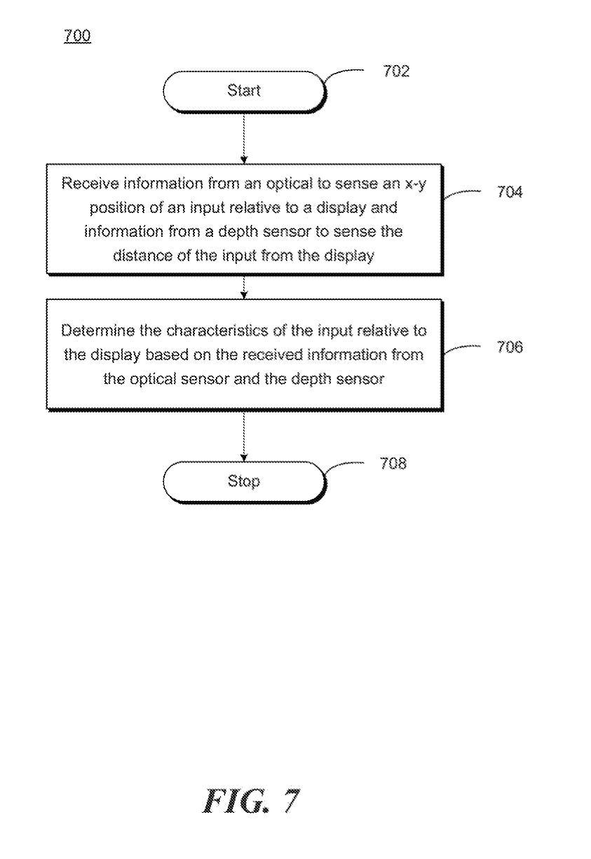

FIG. 7 is a flow chart illustrating one example of a method 700 for evaluating an input relative to a display. For example, the method 700 may be used for determining the characteristics of an input where the optical sensor measures the x-y position of an input relative to the display. For example, the optical sensor may measure the x-y location of the input relative to the display, and the depth sensor may measure the distance of the input from the display. Information about the distance of the input from the display may be used to determine how to categorize the input, such as whether to categorize the input as a touch input. For example, an input within a particular threshold distance of the display may be classified as a touch input. In one implementation, the method 700 is executed using the system 100 shown in FIG. 1.

Beginning at block 702 and moving to block 704, the processor, such as by executing instructions stored in a machine-readable storage medium, receives information from an optical sensor to sense an x-y position of an input relative to the display and information from a depth sensor to sense the distance of the input from the display. The optical sensor may capture the information about the x-y position of an input relative to the display in any suitable manner. For example, the optical sensor may be a camera determining the position of an input or may be a light transmitter and receiver determining whether a light across the display is interrupted. In one implementation, the optical sensor senses additional information in addition to the x-y position of the input relative to the display.

The information from the optical sensor may be received in any suitable manner. For example, the processor may retrieve the information from a storage medium, such as a memory, or receive the information directly from the optical sensor. In some implementations, the processor receives the information via a network.

The depth sensor may capture information related to the distance of an input from the display in any suitable manner. For example, the depth sensor may be a camera for sensing a distance or an infrared depth map. In one implementation, the depth sensor captures information in addition to information about the distance of the input from the display.

The information from the depth sensor may be received in any suitable manner. For example, the processor may retrieve the information, such as from a storage medium, or receive the information from the depth sensor. In one implementation, the processor may communicate with the depth sensor via a network.

Continuing to block 706, the processor determines the characteristics of the input relative to the display based on the received information from the optical sensor and the depth sensor. The processor may determine the characteristics of the input in any suitable manner. For example, the processor may determine a particular characteristic of the input using information from one of the sensors and another characteristic using information from the other sensor. In one implementation, the processor analyzes information from each of the sensors to determine a characteristic of the input.

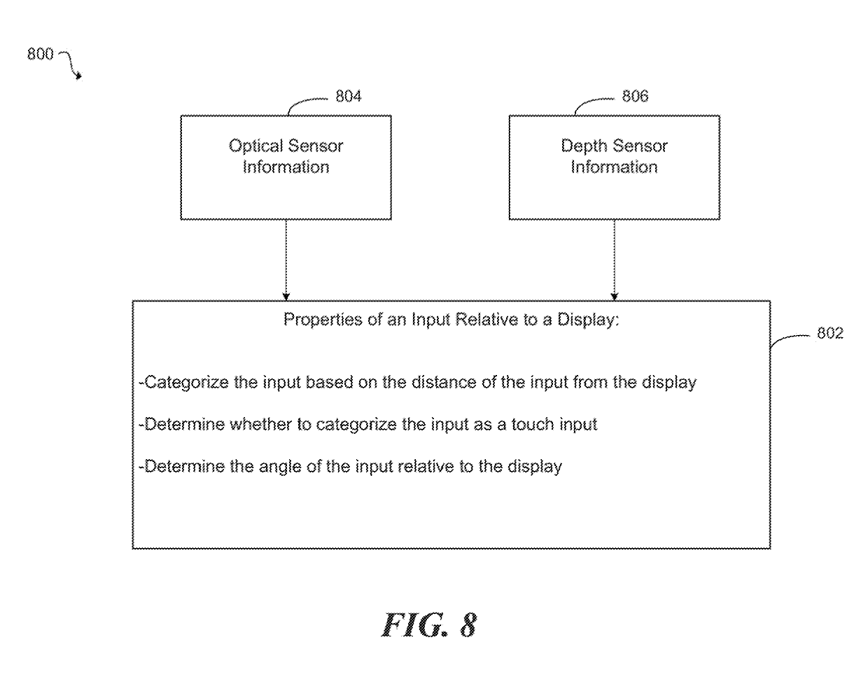

The processor may determine any suitable characteristics of an input relative to the display. Some examples of characteristics that may be determined, such as determining how to categorize the input based on the distance of the input from the display, determining whether to categorize the input as a touch input, and determining the angle of the input, are shown in FIG. 8. Other characteristics are also contemplated. The method 700 may continue to block 708 to end.

FIG. 8 is a block diagram illustrating one example 800 of characteristics of an input determined based an information from an optical sensor and a depth sensor. For example, a processor may determine the characteristics of an input based on optical sensor information 404 from an optical sensor sensing an x-y position of an input along a display and based on the depth sensor information 406 from a depth sensor sensing the distance of the input relative to the display. As shown in block 802, the optical sensor information 804 and the depth sensor information 806 may be used to categorize the input based on the distance from the display, determine whether to categorize the input as a touch input, and determine the angle of the input relative to the display.

The processor may categorize the input based on the distance of the input from the display. The processor may determine the distance of the input from the display using the depth sensor information 806. The processor may determine the x-y location of the input relative to the display, such as whether the input is directly in front of the display, using the optical sensor information 804. For example, the processor may determine to categorize an input as a hover if the input is less than a first distance from the display and greater than a second distance from the display. A hover over the display may be interpreted to have a certain meaning, such as to display a selection menu. In one implementation, the processor may determine to categorize an input as irrelevant if it is more than a particular distance from the display. For example, user interactions sensed a particular distance from a display may be interpreted not to be inputs to the display.

In one implementation, categorizing an input based on the distance of the input from the display includes determining whether to categorize the input as a touch input. For example, the optical sensor information 804 may include information about the x-y position of an input relative to the display, and the depth sensor information 806 may include information about the distance of the input from the display. If the input is within a threshold distance of the display, the processor may determine categorize the input as a touch input. In one implementation, an input categorized as a touch input to the display has a different meaning than an input categorized as a hover input to the display. For example, a touch input may indicate that an item is being opened, and a hover input may indicate that an item is being moved.

In one implementation, the processor determines the angle of an input relative to the display based on the optical sensor information 804 and the depth sensor information 806. For example, the processor may determine the angle of an input using information about the distance of two portions of an input from the display using the depth sensor information 806. In one implementation, the processor may determine an x-y position of an input near the display 110 using the optical sensor information 804 and may determine the distance of another end of the input using the depth sensor information 806. The angle of an input may be associated with a particular meaning. For example, a hand parallel to the display may indicate that an object shown on the display is to be deleted, and a hand positioned at a 45 degree angle towards the display may indicate that an object shown on the display is selected.

After determining the characteristics of the input, the processor may determine the meaning of the input based on the characteristics. For example, the processor may determine that that the input indicates that an item shown on the display is being selected, moved, or opened, A meaning of an input may be interpreted, for example, based on how the input is categorized.

Information from an optical sensor and a depth sensor may be used to better determine the characteristics of an input relative to a display. For example, more properties related to an input may be measured if both an optical sensor and depth sensor are used. In some cases, an input may be measured more accurately if different characteristics of the input are measured by a sensing technology better tailored to the particular characteristic.

1. A method for evaluating an input relative to a display, comprising:
receiving, by a processor, information from an optical sensor to sense an x-y position of an input relative to a display and information from a depth sensor to sense the distance of the input from the display; and
determining, by the processor, the characteristics of the input relative to the display based on the received information from the optical sensor and the depth sensor.

2. The method of claim 1, wherein determining the characteristics of the input relative to the display comprises categorizing the input based on the distance of the input from the display.

3. The method of claim 2, wherein categorizing the input based on the distance of the input from the display comprises categorizing the input as a touch input if the input is within a threshold distance of the display.

4. The method of claim 1, wherein determining the characteristics of the input relative to the display comprises determining the angle of the input relative to the display.

5. A display system to evaluate an input relative to a display, comprising:
a display;
an optical sensor 106 to sense information about an input relative to the display;
a depth sensor 108 to sense the position of the input relative to the display; and
a processor to determine the characteristics of the input relative to the display based on information received from the optical sensor 106 and information received from the depth sensor 108.

6. The display system of claim 5, wherein determining the characteristics of the input relative to the display comprises determining at least one of: position, pose, motion, gesture characteristics, or orientation.

7. The display system of claim 5, wherein the optical sensor 106 comprises a first camera and the depth sensor 108 comprises a second camera of lower resolution than the first camera.

8. The display system of claim 5, wherein the optical sensor 106 comprises two cameras to sense three-dimensional characteristics of the input.

9. The display system of claim 5, wherein determining the characteristics of the input relative to the display comprises categorizing the input based on the distance of the input from the display.

10. The display system of claim 5, further comprising a contact sensor to sense contact with the display, wherein the processor determines the characteristics of a touch input relative to the display based on information received from the contact sensor.

11. A machine-readable storage medium encoded with instructions executable by a processor to evaluate an input relative to a display, the machine-readable medium comprising instructions to:
receive information from an optical sensor to sense information about an input relative to a display and information from a depth sensor to sense the position of the input relative to the display; and
evaluate the properties of the input relative to the display based on the information from the optical sensor and information from the depth sensor.

12. The machine-readable storage medium of claim 11, wherein instructions to evaluate the properties of the input relative to the display comprise instructions to evaluate at least one of: position, pose, motion, gesture characteristics, or orientation.

13. The machine-readable storage medium of claim 11, further comprising instructions to interpret the meaning of the input based on the position of the input relative to the display.

14. The machine-readable storage medium of claim 11, further comprising receiving information from a contact sensor to sense contact with the display, wherein instructions to evaluate the properties of the input relative to the display comprise instructions to evaluate the properties of the input based on information from the contact sensor.

15. The machine-readable storage medium of claim 11, wherein instructions to evaluate the properties of the input comprises instructions to evaluate three-dimensional properties of the input.
